(19) United States
(12) Patent Application Publication
(10) Pub. No.: US 2005/0157321 A1
(43) Pub. Date: Jul. 21, 2005

(54) Printer driver plug-in module management system

(76) Inventor: Arthur E. Alacar, Concord, CA (US)

Correspondence Address: Kyocera Technology Development;Intellectual Property Administration, Suite 400, 1855 Gateway Blvd., Concord, CA, 94520, US

(21) Appl. No.: 10/761,547

(22) Filed: Jan. 20, 2004

(51) Int. Cl. G06F 15/00

(52) U.S. Cl. 358/1.13

(57) ABSTRACT

A method for dynamically augmenting printer drivers, by providing a GUI for selecting plug-in modules, and dynamically adding the selected plug-in modules. Addition and deletion of plug-in modules do not require uninstallation and reinstallation of the currently installed printer driver. Plug-in modules implement optional or model-specific functionalities, including feature sets, Page Description Languages (PDLs), and Renders. Settings for plug-in modules are stored in heap-allocated private devmode structures, which may be deallocated when plug-in modules are removed. Methods include copying DLL files to a printer system folder, checking compatibility of the plug-in DLL files, adding registry entries, plug-in module installing itself, adding GUI tabs, and downloading plug-in modules stored at a remote storage over the network. In an embodiment, registry entries are checked for any plug-in modules, and the corresponding DLL files are copied from a server to a client.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to printer drivers, and more particularly to dynamically augmenting printer drivers by adding plug-in modules to the printer drivers.

### BACKGROUND OF THE INVENTION

Typically, printing from a computer occurs through the use of a printer driver. Upon either an application launch or during a print command load time, the application will call an instance of the printer driver and provide the user with an interface to set the desired printer driver settings. Printer driver settings may also be called printer options, print settings, driver options, printer parameters, print selections, etc. The printer driver settings specify preferences on features of the printer.

Existing printer drivers do not have a modular structure, and monolithically include various feature components. Therefore, to add a new or improved feature to a prior art printer driver, the installed printer driver needs to be first uninstalled, then the new version printer driver that includes the new or improved feature needs to be reinstalled. Thus, with existing printer drivers, the uninstallation and reinstallation steps are cumbersome, and may require rebooting of the computer. Furthermore, the absence of modular structure in the printer driver makes maintaining the source code difficult.

The present invention arose out of the above concerns associated with providing improved printer drivers and methods of providing printer drivers.

### SUMMARY OF THE INVENTION

Methods, programming products, and printing systems for dynamically augmenting printer drivers by providing a GUI for selecting plug-in modules, and dynamically adding plug-in modules to the printer drivers are described.

Addition and deletion of plug-in modules do not require uninstallation and reinstallation of the currently installed printer driver. Thus a printer driver is dynamically augmented and modified.

Plug-in modules implement optional or model-specific printing features, including feature sets, Page Description Languages (PDLs) and Renders. The typical optional or model-specific functionalities include watermark, punch, finisher, staple, Prologue/epilogue, profile, MACRO generator, etc.

Printer settings for plug-in modules are stored in heap-allocated private devmode structures, which may be deallocated when plug-in modules are removed.

Methods include copying DLL files to a printer system folder, checking compatibility of the plug-in DLL files, adding registry entries, plug-in module installing itself, adding GUI tabs, and downloading plug-in modules stored at a remote storage over the network.

In an embodiment, registry entries are checked for any plug-in modules, and the corresponding DLL files are copied from a server to a client.

The invention will be more fully understood upon consideration of the detailed description below, taken together with the accompanying drawings.

### DESCRIPTION OF THE DRAWINGS

FIG. 1 is a simplified block diagram showing connection of a computing system to a printer.

FIG. 2 is a view of the GUI (Graphical User Interface) for selecting plug-in modules to install in accordance with a preferred embodiment of the present invention.

FIG. 3 is a block diagram of an exemplary computing system employing principles of the invention.

FIG. 4 is a block diagram of an exemplary computing system employing principles of the invention, including the downloading of plug-in modules stored in a remote storage site.

FIG. 5 is a diagram showing allocation of private devmode structures in a plug-in module management system employing principles of the invention.

FIG. 6 is a diagram showing deallocation of private devmode structures in a plug-in module management system employing principles of the invention.

FIG. 7 is a flowchart showing addition of plug-in modules in a computing system employing principles of the invention.

FIG. 8 is a flowchart showing removal of plug-in modules in a computing system employing principles of the invention.

FIG. 9 is a flowchart showing installation of a printer in a client-server environment in a computing system employing principles of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

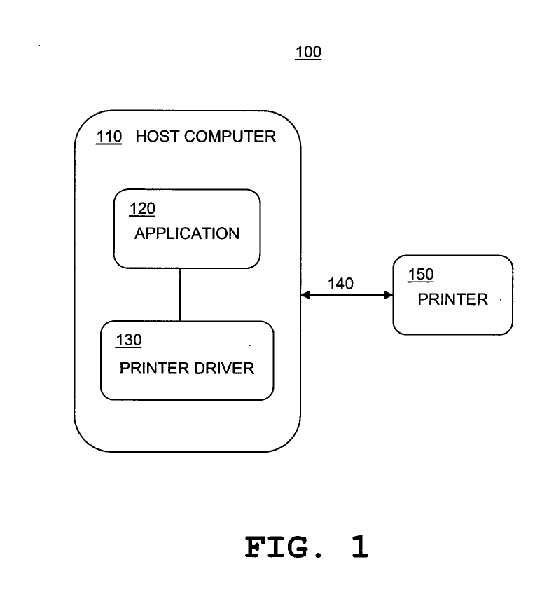

FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

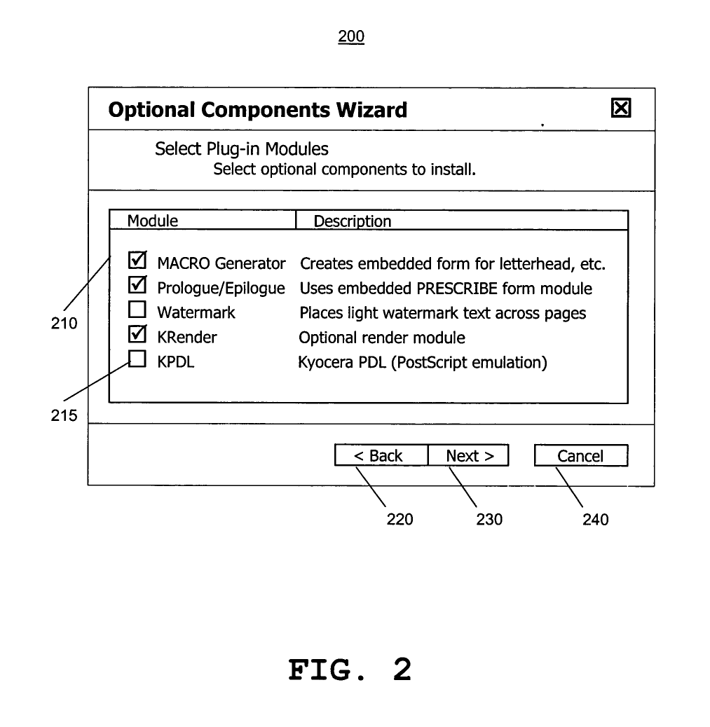

FIG. 2 is a view of the GUI (Graphical User Interface) for selecting plug-in modules to install in accordance with a preferred embodiment of the present invention. A user can use this GUI or wizard 200 to specify the plug-in modules to be added to the printer driver. Here named the “Optional Components Wizard,” the wizard 200 is typically entered by clicking on the appropriate buttons in the printer Properties menu, or through a separate external application. The external application, called a post-installer utility, is included in the driver package.

The list region 210 of the wizard 200 lists the available plug-in modules and their brief descriptions. The user specifies the plug-in modules to be added to the printer driver by checking the checkboxes 215 included in the list region 210.

The list region 210 in this exemplary view of the GUI 200 includes optional or model-specific printing features, including feature sets, Page Description Languages (PDLs) and Renders. Feature sets implement optional or model-specific functionalities that relate to at least one printer model, including watermark, punch, finisher, staple, Prologue/epilogue, profile, etc.

Page Description Languages (PDLs) receive print requests and converts them to a stream of commands that the printer's graphics language needs to actually print the desired graphics and text on a hard copy page in the physical printer. Exemplary PDLs include PCL, Postscript, KPDL (Kyocera Page Description Language), MACRO generator, etc.

Render plug-in modules are used for enhanced image processing, including color processing such as modifying intensity and color levels. Other processing by render plug-in modules include scaling, clipping, and color halftoning.

The Back button 220 is used to go back to the last menu in the wizard 200. The Next button 230 is used to advance to the next menu in the wizard 200, which typically is a confirmation screen displaying the list of plug-in modules to be added. The Cancel button 240 is used to exit the wizard 200 without causing addition of any plug-in modules.

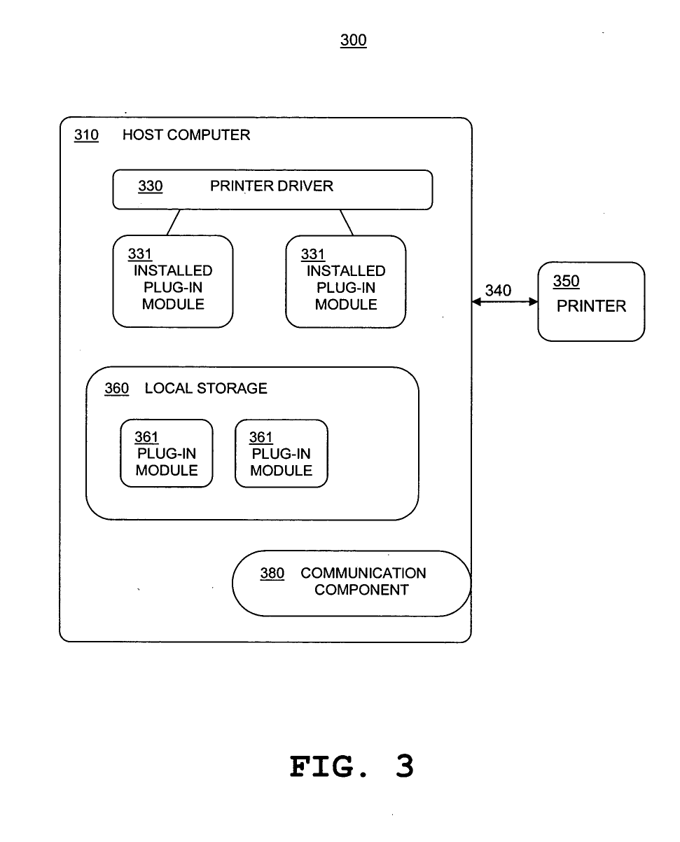

FIG. 3 is a diagram illustrating an exemplary computer system 300 employing the principles of this invention to dynamically augment a printer driver by adding plug-in modules to the printer driver. Host computer 310, printer driver 330, printer I/O interface connection 340, and printer 350 are as described in FIG. 1.

As shown previously in FIG. 2, the user specifies the plug-in modules to be added to the printer driver by checking the checkboxes 215 included in the list region 210. The list region 210 displays all available plug-in modules 361 stored in the local storage 360, which is typically the hard disk drive of the host computer 310. By checking the checkboxes 215 the user specifies a subset of the available plug-in modules 361 stored in the local storage 360. When the user directs the at least one plug-in module to be added, this causes the specified subset of the plug-modules to be installed in the printer driver 330.

The installed features implemented by the installed plug-in modules 331 become available for use. These features are typically optional and printer-model-specific features, including watermark, punch, finisher, staple, Prologue/epilogue, profile, MACRO generator, etc.

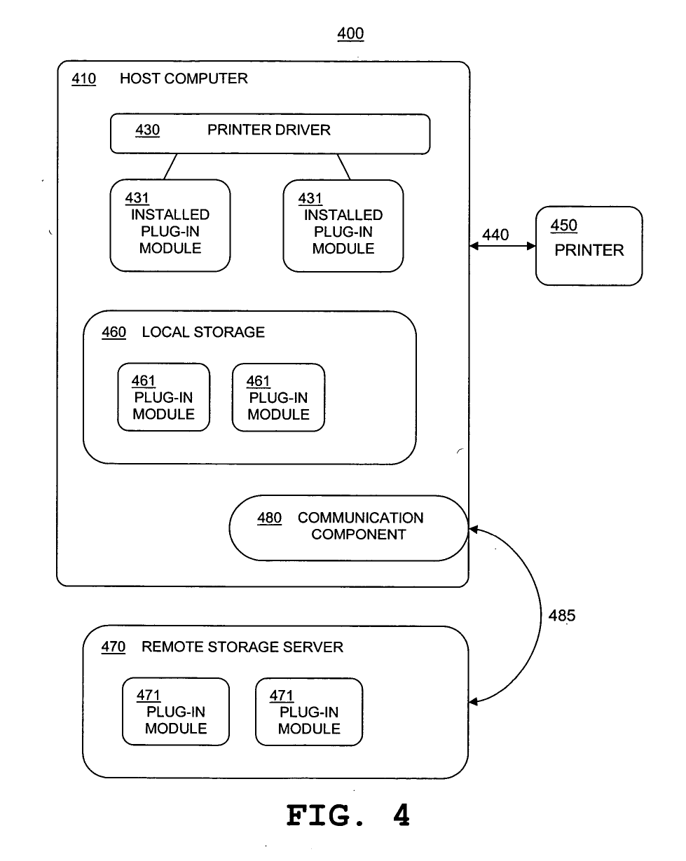

The details of how the available plug-in modules 361 stored in the local storage 360 become installed in the printer driver 330 are described below. The communication component 380 is used to download plug-in modules from a remote storage through the network. It will be described in the next figure, FIG. 4.

FIG. 4 is a diagram illustrating an exemplary computer system 400 employing the principles of this invention to dynamically augment a printer driver by adding plug-in modules to the printer driver, including the downloading of plug-in modules stored in a remote storage server 470. The host computer 410, printer driver 430, printer I/O interface connection 440, and printer 450 are as described in FIG. 1. FIG. 4 illustrates the manner in which plug-in modules 471 stored in a remote storage server 470 are downloaded through the network 485 and the communication component 480 for installation in the printer driver 430.

The remote storage server 470 is typically a download site provided by the printer manufacturers. It is also possible, however, for a third party developer to provide a plug-in module from its download site, and it is also possible for other parties, such as a printer user's information systems department, to provide plug-in modules for downloading. Depending on the location of the remote storage server 470, the network connection 485 may be an internet connection, a parallel interface connection or any other method of connecting a computer to another computer used in the art, e.g., a serial interface connection, a remote network connection, a wireless connection, an infrared connection, etc.

The communication component 480 may take a variety of different configurations which may access a local area network (LAN), wide area network (WAN), an internet network, a public telephone network or a private value added network (VAN). Alternatively, the communication network can be implemented using any combination of these different kinds of communication networks. In a preferred embodiment, the communication component is a TCP/IP communication controller with the appropriate digital switching capability accessible over the Internet. The hardware portion of this communication could have a protocol stack which could be Ethernet, token ring, Bluetooth, IEEE802.11B, or any other convenient software protocol to facilitate the transfer of IP packets over a network.

A GUI menu similar to FIG. 2 is used to allow the user to specify the location of the remote storage server 470. When the user directs the specified plug-in modules to be added, this causes the specified subset of the plug-modules to be installed in the printer driver 430.

Except for the fact that the plug-in modules are transferred through the communication component 480 and the network 485, the installation of the plug-in modules is essentially the same as described in FIG. 3, and the details of the installation process are described below. Varieties of known methods can also be used, including searching and locating of the remote storage servers or remote storage sites, providing a default, priority, or hierarchy to the ordering of multiple sites, and authenticating the site to ensure the integrity of the plug-in modules.

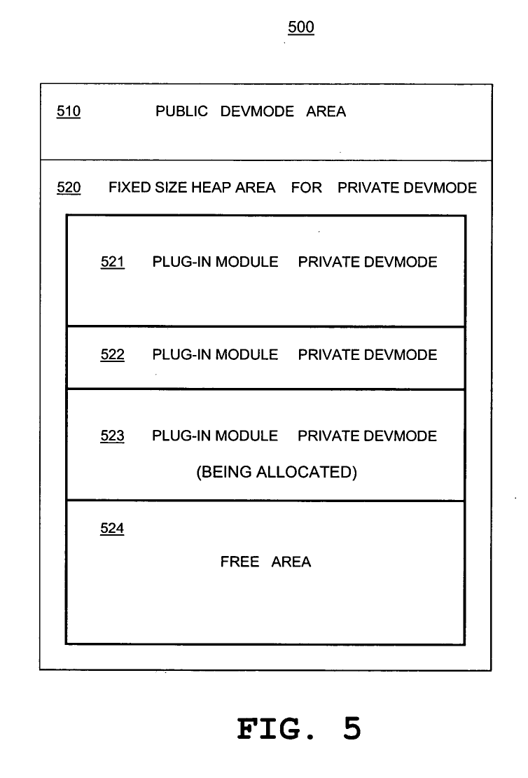

FIG. 5 is a diagram of devmode memory areas 500 showing allocation of private devmode structures in a plug-in module management system employing principles of the invention. In prior art systems, a public devmode area is followed by a private devmode area. In an embodiment of this invention, a public devmode area 510 is followed by a fixed size heap area 520 for private devmode structures. The size of the heap area should be large enough to accommodate the private devmode structures for all the plug-in modules that are expected to be installed at the same time.

The printer driver settings specify preferences on features of the printer. Some of these features are common to all or most printers, e.g., number of copies, double-sided printing, paper size, orientation, etc., whereas other features are optional and printer-model-specific features that may vary depending on the particular model and printer manufacturer, e.g., color, ink volume, watermark, punch, finisher, and staple.

A devmode data structure contains information about the device initialization and configuration of documents in the printer. Settings for features that are common to all or most printers are stored in the public devmode, whereas settings for features that are optional and printer-model-specific are stored in the private devmode.

The devmode memory areas 500 begin with the public devmode area 510 that refers to the information defined by Microsoft valid to all devices. A printer driver's private data area 520 follows the public portion of the devmode structure, the public devmode area 510. The size of the public data varies depending on Windows version. The dmSize member specifies the number of bytes in the public area while dmDriverExtra refers to the size in bytes of the private portion. The private devmode heap area 520 has a fixed size.

The fixed size heap area for private devmode 520 contains a series of different devmode structures of different sizes used by the installed modules. Each block of data typically starts with PD_HEADER that begins with a code to identify a valid entry. This code is typically small, e.g. 1 byte, 2 bytes, 4 bytes, etc. The PD_HEADER typically also contains information on the actual size in bytes of the structure usually used in traversing through the private devmode portion. Following the header is the data area, where the data for the settings is stored. The first private devmode structure 521 may be the PD_MAIN, which is considered to be a standard feature and must always be the first entry in the private devmode area 520. Other structures may be arranged in no specific order. Typically a new private devmode structure is allocated at the first available position from the beginning.

In FIG. 5, private devmode structures for currently installed plug-in modules 521, 522 occupy the beginning portion of the heap area 520, and the private devmode structure 523 for the plug-in module being installed is being allocated at the next available and contiguous position. The free area 524 decreases by the size of the new private devmode structure 523. Depending on the specific requirements, it is also possible to use an improvement or variations on the basic heap-allocation methods.

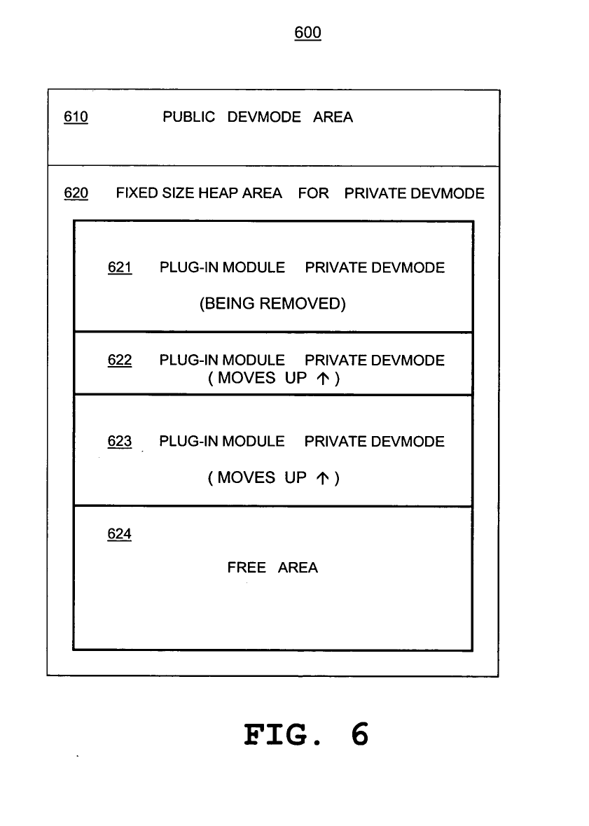

FIG. 6 is a diagram of devmode memory areas 600 showing deallocation of private devmode structures in a plug-in module management system employing principles of the invention. When a plug-in module is removed, the corresponding private devmode structure may be deallocated. Some plug-in modules do not require data to be stored in a private devmode structure, in which case, no private devmode structure is allocated when it is installed, and therefore there is no need to deallocate a private devmode structure.

In FIG. 6, private devmode structures for currently installed plug-in modules 621, 622, 623 occupy the beginning portion of the heap area 620, and the private devmode structure 621 for the plug-in module being uninstalled is being deallocated. This typically causes all the subsequent private devmode structures 622, 623 to be relocated, so that they move up to occupy the beginning portion of the heap area 620. At all times, the active private devmode structures occupy the contiguous, beginning portion of the heap area 620. The free area 524 decreases by the size of the removed private devmode structure 621. Depending on the specific requirements, it is also possible to use an improvement or variations on the basic heap-allocation methods.

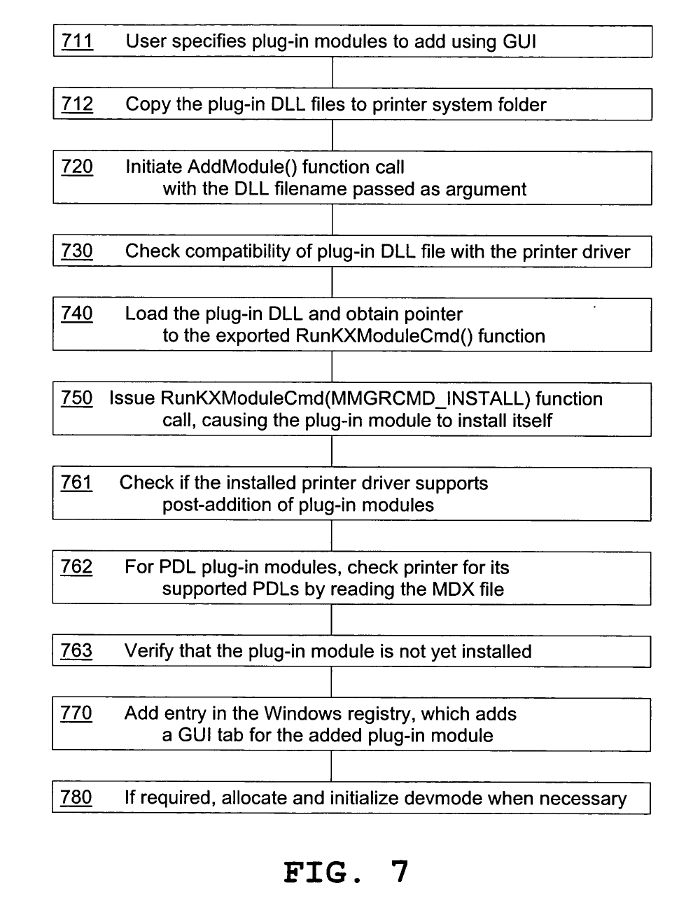

FIG. 7 is a flowchart showing addition of plug-in modules in a computing system employing principles of the invention.

In step 711, a user specifies the plug-in modules to be added to the printer driver. This is done from a GUI similar to FIG. 2, which may be part of the printer driver or a separate external application. The external application, called a post-installer utility, is included in the driver package.

In step 712, when the user then directs the specified plug-in modules to be added to the printer driver, the corresponding plug-in DLL files are copied to the printer system folder. The actual location of the printer system folder is dependent on the printer driver and the operating system version. In Windows they may be % WINDIR %\system32\spool\drivers\w32×86\2 for kernel mode driver or % WINDIR %\system32\spool\drivers\w32×86\3 for the user mode driver.

Use of DLL (Dynamic Linking Library) files is known in the art.

In step 720, after the DLL files are copied, a printer driver component or post-installer program initiates an AddModule( ) function call with the DLL filename passed as argument. AddModule( ) is the name of the function that initiates addition of plug-in module in the printer driver, passing the plug-in DLL file as an argument.

In step 730, a compatibility checking between the plug-in DLL file and the printer driver is made. This includes checking to make sure that the version information of the plug-in DLL file is compatible with the installed printer driver. The addition of the plug-in will stop if the DLL version is found to be incompatible with the printer driver.

In step 740, the DLL file passed as argument to AddModule( ) is then loaded by a call to LoadLibrary( ) and a pointer to the exported RunKXModuleCmd( ) function is obtained. RunKXModuleCmd( ) is the name of the function that acts as the main interface between the printer driver and the plug-in DLL during plug-in setup.

In step 750, RunKXModuleCmd(MMGRCMD_INSTALL) function call is issued, causing the plug-in module to install itself. The process of a plug-in module installing itself includes the steps 761, 762, 763, and 770.

In step 761, the plug-in module begins various checking. It first checks to see if the installed printer driver supports post-addition of plug-in modules. If addition of plug-in modules is not supported by the printer driver, the addition process stops.

In step 762, the plug-in module continues with more checking. For PDL plug-ins, printer is checked for its supported PDLs by reading the MDX file. Installation fails if the particular PDL module is not supported, and the addition process stops.

In step 763, the plug-in module continues with more checking. It verifies that plug-in module is not yet installed. If it is already installed, the addition process stops.

In step 770, when all the conditions in the last step are satisfied, an entry in the Windows registry is added. The name of the registry entry is FeatureSet1, PDL1, or Render1, etc. depending on the type of the plug-in module. The plug-in module is set as enabled by default. For each printer installed in a Windows operating system, an entry exists in the Windows operating system registry. A registry is a hierarchically arranged database and includes various branches for storing references to many of the system's resources, including joystick configurations, keyboard layouts, fonts, printers and the like.

Addition of the registry entry results in a new GUI tab for the added plug-in module to be included in the printer driver setting GUI. This is achieved by the printer driver which checks the registry entries when the printer driver is loaded.

In step 780, a new devmode structure is allocated and initialized if necessary. Allocation and initialization of a new devmode structure may not be necessary because some plug-in modules do not require any area in the private devmode. The devmode structure may be allocated and initialized only when necessary, that is, the devmode structure may be initialized by the printer driver when the plug-in module is loaded for the first time for UI display or printing.

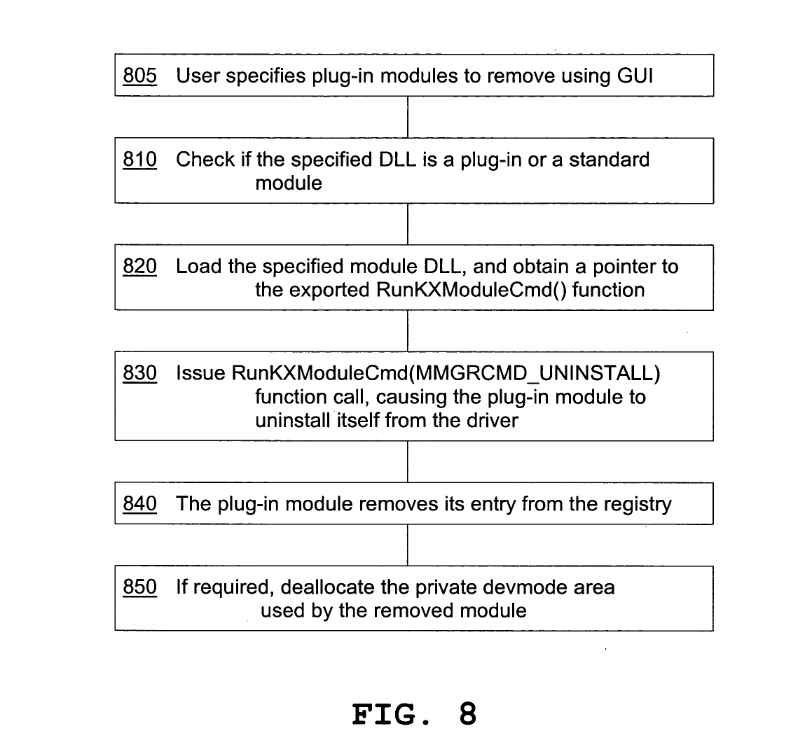

FIG. 8 is a flowchart showing removal of plug-in modules in a computing system employing principles of the invention.

In step 805, a user specifies the plug-in modules to be deleted from the printer driver. This is done from a GUI similar to FIG. 2, which may be part of the printer driver or a separate external application. The external application, called a post-installer utility, is included in the driver package.

In step 810, RemoveModule( ) checks if the specified DLL is a plug-in or a standard module. Since only plug-in modules can be removed, if the specified DLL is a standard module, the removal process stops.

In step 820, the specified module DLL is loaded by a call to LoadLibrary( ), a pointer to the exported RunKXModuleCmd( ) function is obtained.

In step 830, RunKXModuleCmd(MMGRCMD_UNINSTALL) function call is issued, causing the plug-in module to uninstall itself from the printer driver. RunKXModuleCmd( ) is the name of the function that acts as the main interface between the printer driver and the plug-in DLL during plug-in setup (both addition and removal).

In step 840, the plug-in module removes its entry from the Windows registry. For each printer installed in a Windows operating system, an entry exists in the Windows operating system registry. A registry is a hierarchically arranged database and includes various branches for storing references to many of the system's resources, including joystick configurations, keyboard layouts, fonts, printers and the like.

In step 850, the private devmode structure corresponding to the specified plug-in module being deleted is deallocated if necessary. Deallocation the private devmode structure may not be necessary because some plug-in modules do not require any area in the private devmode. The devmode structure may be deallocated only when necessary, that is, the devmode structure may be deallocated when the printer driver is loaded.

In an embodiment of the invention, the actual plug-in module file in the printer driver system folder is never deleted to avoid possible conflict with other installed driver components. In another embodiment of the invention, in which a possible conflicted is detected in advance, the actual plug-in module file in the printer driver system folder is deleted when it is confirmed that no possible conflict exists.

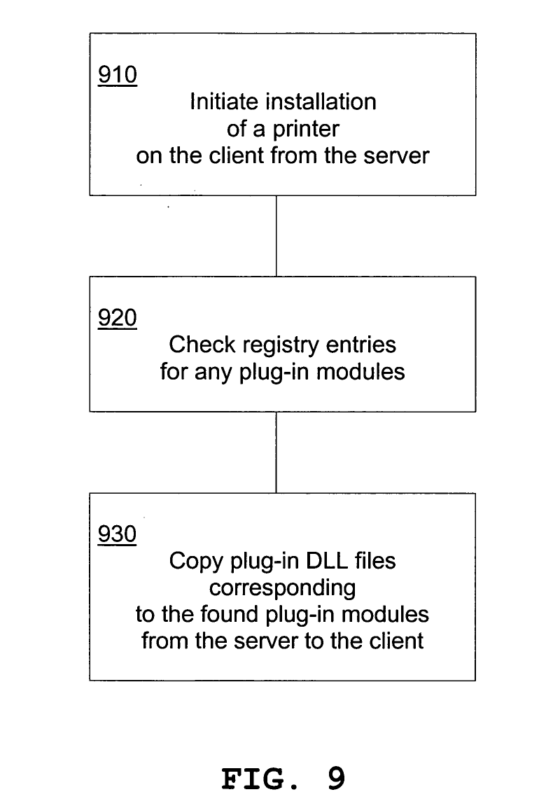

FIG. 9 is a flowchart showing installation of a printer in a client-server environment in a computing system employing principles of the invention.

In Windows environment, device drivers must have an INF file in order to be installed. An INF file is a text file that contains all the information necessary to install a device, such as driver names and locations, registry information, version information, that is used by the Setup components. Use of INF files is known in the art.

In a client-server computing environment, in which a printer is connected to a server computer, when a user installs a printer on the client computer from the server computer, only the files listed in the INF file are copied by Windows from server to the client machine. Thus, Windows may not copy the plug-in module files corresponding to the plug-in modules that were added using the embodiments of this invention. Therefore, the following steps are performed in an embodiment of this invention in order to make sure that the plug-in modules installed on the server are also installed in the client.

In step 910, installation of a printer on the client computer from the server computer is initiated. This is typically performed using the installation wizard of the printer driver.

In step 920, registry entries are checked for any plug-in modules that were additionally installed in the printer driver. The name of the registry entry for a plug-in module is FeatureSet1, PDL1, or Render1, etc. depending on the type of the plug-in module.

In step 930, if any registry entries for plug-in modules are found, the corresponding plug-in DLL files are copied by the printer driver from the server computer to the client computer. These are the DLL files that may not have been copied by the default action of the Windows operating system.

Although this invention has been largely described using Windows terminology, one skilled in this art could see how the disclosed methods can be used with other operating systems, such as DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

1. A method for augmenting a printer driver, comprising: providing a GUI for selecting at least one plug-in module; and dynamically adding the at least one plug-in module to the printer driver.

2. The method of claim 1, wherein the adding of the at least one plug-in module comprises copying at least one plug-in DLL file to a printer system folder.

3. The method of claim 1, wherein the adding of the at least one plug-in module comprises checking compatibility of at least one plug-in DLL file with the printer driver.

4. The method of claim 1, wherein the adding of the at least one plug-in module comprises the at least one plug-in module installing itself.

5. The method of claim 1, wherein the adding of the at least one plug-in module comprises adding at least one registry entry.

6. The method of claim 1, wherein the adding of the at least one plug-in module comprises heap-allocating and initializing at least one private devmode structure.

7. The method of claim 6, wherein the heap is a private devmode area following a public devmode area.

8. The method of claim 7, wherein the heap is fixed size.

9. The method of claim 6, wherein each of the at least one private devmode structure corresponds to each of the at least one plug-in module added, each of which implements an optional feature selected from the group consisting of feature sets, Page Description Languages (PDLs), and Renders.

10. The method of claim 1, further comprising: providing a GUI by which a user selects at least one plug-in module; and removing the at least one plug-in module from the printer driver.

11. The method of claim 10 wherein the removing of the at least one plug-in module comprises deallocating at least one private devmode structure.

12. The method of claim 1, wherein the at least one plug-in module is stored at a remote storage on the network.

13. The method of claim 1, wherein the adding of the at least one plug-in module comprises checking at least one registry entry for at least one added plug-in module; and copying at least one DLL file corresponding to the added at least one plug-in module from a server to a client.

14. The method of claim 1, wherein the adding of the at least one plug-in module comprises adding at least one GUI tab for the added at least one plug-in module.

15. A computer program product for augmenting a printer driver, comprising machine-readable program code for causing a machine to perform the method steps of: providing a GUI for selecting at least one plug-in module; and dynamically adding the at least one plug-in module to the printer driver

16. The computer program product of claim 15, wherein the dynamically adding of the at least one plug-in module comprises copying at least one plug-in DLL file to a printer system folder; checking compatibility of the at least one plug-in DLL file with the printer driver; and adding at least one registry entry.

17. The computer program product of claim 15, wherein the dynamically adding of the at least one plug-in module comprises heap-allocating and initializing at least one private devmode structure.

18. The computer program product of claim 15, wherein the at least one plug-in module is stored at a remote storage on the network.

19. A printing system, comprising: a print engine; and a printer driver programmed to augment the printer driver by performing the steps of providing a GUI for selecting at least one plug-in module; and dynamically adding the at least one plug-in module to the printer driver.

20. The printing system of claim 19, wherein the adding of the at least one plug-in module comprises copying at least one plug-in DLL file to a printer system folder; checking compatibility of the at least one plug-in DLL file with the printer driver; and adding at least one registry entry.

21. The printing system of claim 19, wherein the adding of the at least one plug-in module comprises heap-allocating and initializing at least one private devmode structure.

22. The printing system of claim 19, wherein the at least one plug-in module is stored at a remote storage on the network.
